(19) United States
(12) Patent Application Publication
(10) Pub. No.: US 2026/0116286 A1
(43) Pub. Date: Apr. 30, 2026

(54) SYSTEMS AND METHODS FOR SIGNALING TO VEHICLES WITH DETECTED HIGH BEAMS

(71) Applicant: Torc Robotics, Inc., Blacksburg, VA (US)

(72) Inventors: William Gray Davis, Austin, TX (US); Akshay Pai Raikar, Austin, TX (US); Garrett Madsen, Austin, TX (US); Joseph R. Fox-Rabinovitz, Austin, TX (US)

(21) Appl. No.: 18/927,561

(22) Filed: Oct. 25, 2024

(51) Int. Cl. B60Q 1/50; G01S 17/04; G01S 17/08; G01S 17/88

(52) U.S. Cl. CPC B60Q 1/547; B60Q 1/507; G01S 17/04; G01S 17/08; G01S 17/88; B60Q 2300/42

(57) ABSTRACT

A system of an autonomous vehicle is disclosed. The system includes one or more processors, a plurality of sensors mounted on the autonomous vehicle and communicatively coupled to the one or more processors, and a memory storing instructions. When executed by the one or more processors, the instructions configure the system to receive, from the plurality of sensors, vehicle detection data and first sensor data, wherein the first sensor data is associated with a light amount emitted by a detected vehicle, and measure, by the plurality of sensors, a distance between the detected vehicle and the autonomous vehicle. The instructions also configure the system to determine, via on the first sensor data and the measured distance between the detected vehicle and the autonomous vehicle, a vehicle high beam status of the detected vehicle, wherein the vehicle high beam status is associated with emitted high beam light by the detected vehicle.

### TECHNICAL FIELD

The field of the disclosure relates generally to autonomous vehicle systems and methods and, more specifically, to systems and methods for detecting vehicle high beams of a surrounding vehicle and signaling to the surrounding vehicle using high beams of the autonomous vehicle.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a system of an autonomous vehicle is disclosed. The system includes one or more processors, a plurality of sensors mounted on the autonomous vehicle and communicatively coupled to the one or more processors, and a memory storing instructions. When executed by the one or more processors, the instructions configure the system to receive, from the plurality of sensors, vehicle detection data, receive, from the plurality of sensors, first sensor data, wherein the first sensor data is associated with a light amount emitted by a detected vehicle, and measure, by the plurality of sensors, a distance between the detected vehicle and the autonomous vehicle. The instructions also configure the system to determine, via on the first sensor data and the measured distance between the detected vehicle and the autonomous vehicle, a vehicle high beam status of the detected vehicle, wherein the vehicle high beam status is associated with emitted high beam light by the detected vehicle. The instructions further configure the system to measure, via the plurality of sensors, an ambient light, measure, via the plurality of sensors, a light difference between the measured ambient light and the light amount emitted by the detected vehicle, and determine, based on the light difference, the vehicle high beam status of the detected vehicle.

In another aspect, a computer-implemented method is disclosed. The computer-implemented method includes receiving, from a plurality of sensors mounted on an autonomous vehicle, vehicle detection data comprising a detected vehicle, receiving, from the plurality of sensors, first sensor data, wherein the first sensor data is associated with a light amount emitted by the detected vehicle, and measuring, by the plurality of sensors, a distance between the detected vehicle and the autonomous vehicle. The computer-implemented method also includes determining, based on the first sensor data and the measured distance between the detected vehicle and the autonomous vehicle, a vehicle high beam status of the detected vehicle, wherein the vehicle high beam status is associated with emitted high beam light by the detected vehicle. The computer-implemented method further includes measuring, via the plurality of sensors, an ambient light, measuring, via the plurality of sensors, a light difference between the measured ambient light and the light amount emitted by the detected vehicle, and determining, based on the light difference, the vehicle high beam status of the detected vehicle.

In still another aspect, a non-transitory computer-readable storage medium is disclosed. The non-transitory computer-readable storage medium includes instructions that when executed by a computer, cause the computer to receive, from a plurality of sensors mounted on an autonomous vehicle, vehicle detection data comprising a detected vehicle, receive, from the plurality of sensors, first sensor data, wherein the first sensor data is associated with a light amount emitted by the detected vehicle, and measure, by the plurality of sensors, a distance between the detected vehicle and the autonomous vehicle. The instructions also cause the computer to determine, based on the first sensor data and the measured distance between the detected vehicle and the autonomous vehicle, a vehicle high beam status of the detected vehicle, wherein the vehicle high beam status is associated with emitted high beam light by the detected vehicle. The instructions further cause the computer to measure, via the plurality of sensors, an ambient light, measure, via the plurality of sensors, a light difference between the measured ambient light and the light amount emitted by the detected vehicle, and determine, based on the light difference, the vehicle high beam status of the detected vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIGS. 3-5 are bird's-eye views of a roadway including a schematic of the autonomous truck shown in FIG. 1 and another vehicle; and

FIG. 6 is a block diagram of an example computing system.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

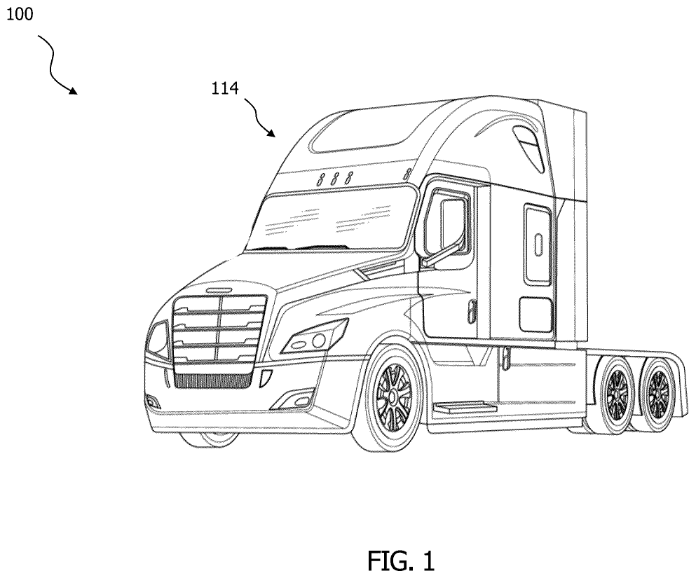

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors.

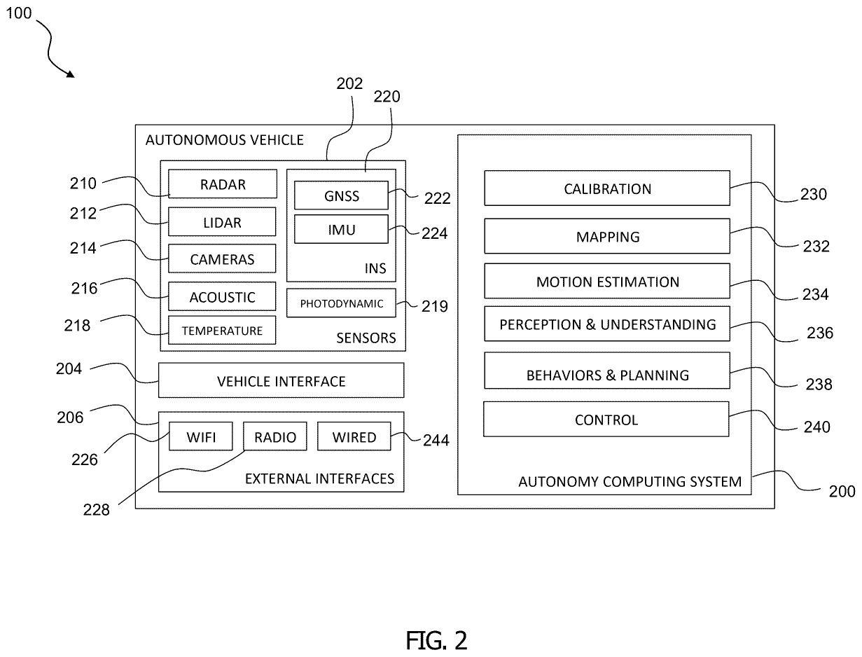

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, photodynamic sensors 219 (e.g., photodiodes), or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, the image data generated by cameras 214 may be sent to autonomy computing system 200 or other aspects of autonomous vehicle 100 or a hub or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify objects in the environment around the autonomous vehicle 100.

Photodynamic sensors 219 generally include a photodiode, e.g., a semiconductor diode, to measure visible light. Specifically, the photodynamic sensors 219 may measure the difference between ambient light surrounding the autonomous vehicle 100 and vehicle light emitted from one or more vehicles surrounding the autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, and a control module or controller 240. The mass and center of gravity measurement module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The perception and understanding module 236 may perform one or more tasks including, but not limited to, detecting high beams from headlights of one or more surrounding vehicles. For example, the perception and understanding module 236 may detect, using the light detection and ranging (LiDAR) sensors 212, the cameras 214, and/or the photodynamic sensors 219, the visible light surrounding the autonomous vehicle 100 to determine the state of headlights of other vehicles on the roadway.

In certain embodiments, the images captured by the cameras 214 may be used by the perception and understanding module 236 to approximate the amount of light given off by vehicles detected by the cameras 214 (e.g., vehicle detection data). In some embodiments, the amount of light detected by the cameras 214 may be compared to a state threshold (e.g., a single value or a range of values) of vehicle high beam light, such as set by a state law and/or regulation (e.g., regulatory data) that includes a permitted intensity of vehicle high beam light.

In certain embodiments, the data collected by the LiDAR sensors 212 may be used by the perception and understanding module 236 to measure a distance between the autonomous vehicle 100 and the vehicle(s) detected by the cameras 214. In some embodiments, the distance between the autonomous vehicle 100 and the vehicle(s) detected by the cameras 214 may be measured by only one of the one or more of the LiDAR sensors 212 and the cameras 214. In other embodiments, a combination of sensors may be used to measure the distance between the autonomous vehicle 100 and the vehicle(s) detected by the cameras 214, such as, but not limited to, one or more of the LiDAR sensors 212 and the cameras 214.

The perception and understanding module 236 may analyze the amount of light detected by the cameras 214 and the distance between the autonomous vehicle 100 and the vehicle(s) detected by the cameras 214 to determine whether the detected vehicle(s) are using their high beams. In some embodiments, this analysis by the perception and understanding module 236 may be used as an input into a machine learning model to categorize vehicle high beam use.

In certain embodiments, the data collected by the photodynamic sensors 219 may be used by the perception and understanding module 236 to measure a light difference between the ambient light and the light being emitted by the detected vehicle(s) surrounding the autonomous vehicle 100. The perception and understanding module 236 may use the analysis of whether the detected vehicle(s) are using their high beams, based on the amount of light detected by the cameras 214 and the distance between the autonomous vehicle 100 and the vehicle(s) detected by the cameras 214, in combination with the light difference measured by the photodynamic sensors 219 to confirm the detected vehicle(s) are using their high beams.

The behaviors and planning module 238 may perform one or more tasks including, but not limited to, signaling to the one or more surrounding vehicles with detected high beams. For example, the behaviors and planning module 238 may signal, using the headlights of the autonomous vehicle 100, to the one or more surrounding vehicles by flashing the high beams of the autonomous vehicle 100.

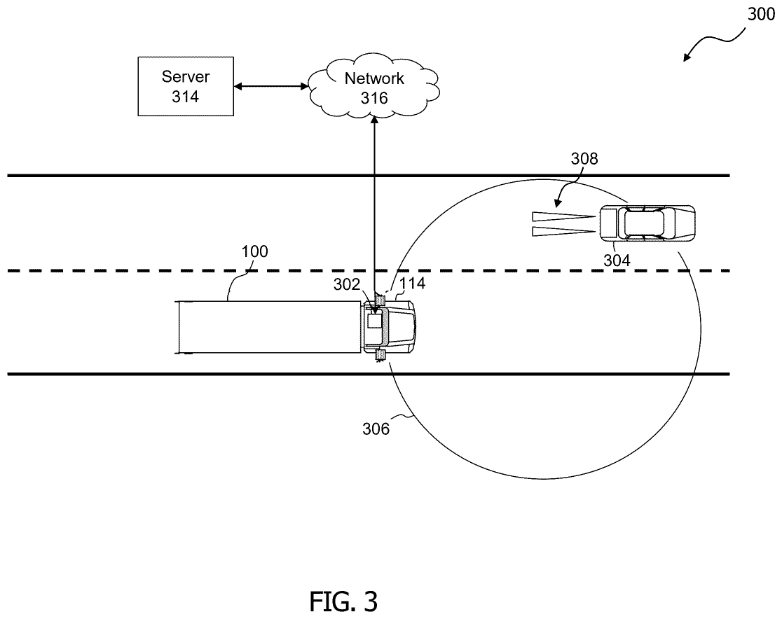

FIGS. 3-5 are bird's-eye views of a roadway environment 300 including a schematic of the autonomous vehicle 100 and aspects of an autonomy system 302 of the autonomous vehicle 100. The autonomy system 302 includes the perception and understanding module 236 (not shown in FIGS. 3-5) and the behaviors and planning module 238 (not shown in FIGS. 3-5) previously described. To interpret the surrounding environment, the perception and understanding module 236 in the autonomy system 302 of the autonomous vehicle 100 may detect a vehicle 304 on the road in a perception area 306 of the autonomous vehicle 100 using, for example, the cameras 214 (not shown in FIGS. 3-5), the LiDAR sensors 212 (not shown in FIGS. 3-5), and/or the photodynamic sensors 219 (not shown in FIGS. 3-5).

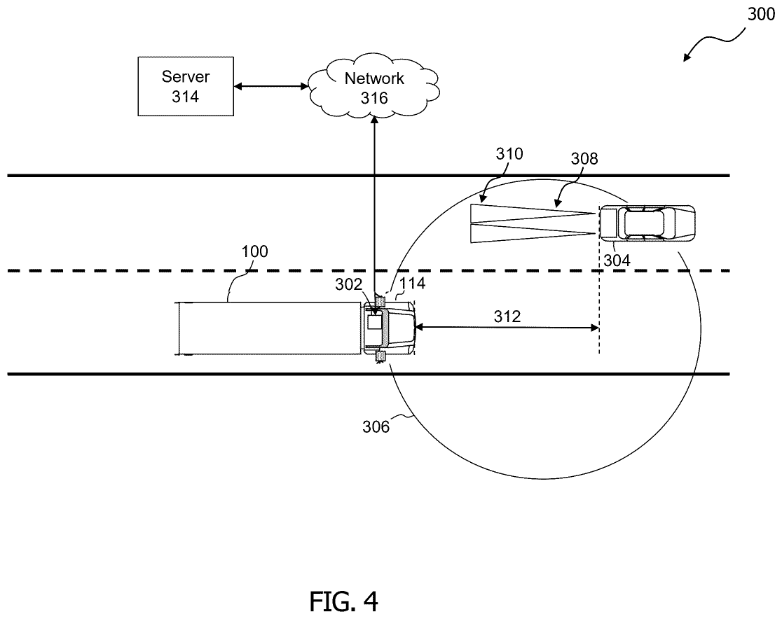

The perception and understanding module 236 may also measure a light amount 308 emitted by the vehicle 304, using the cameras 214, to determine whether the vehicle 304 is using its high beams. In some embodiments, the light amount 308 detected by the cameras 214 may be compared to a state threshold of vehicle high beam light (such as a state law and/or regulation that includes a permitted intensity of vehicle high beam light and/or when vehicle high beam lights may be used) to classify the light amount 308 within a range classified as a vehicle high beam status 310 (as shown in FIG. 4).

As shown in FIG. 4, the perception and understanding module 236 may also collect data to measure a distance 312 between the autonomous vehicle 100 and the vehicle 304 detected by the cameras 214. The perception and understanding module 236 may analyze the light amount 308 detected by the cameras 214 and the distance 312 between the autonomous vehicle 100 and the vehicle 304 to classify the vehicle 304 with the vehicle high beam status 310.

The perception and understanding module 236 may also collect data to measure a light difference between the ambient light and the light amount 308 being emitted by the vehicle 304. The perception and understanding module 236 may use the analysis of whether the vehicle 304 is using its high beams, based on the light amount 308 detected by the cameras 214 and the distance between the autonomous vehicle 100 and the vehicle 304, in combination with the light difference measured by the photodynamic sensors 219 to confirm the classification of the vehicle 304 with the vehicle high beam status 310.

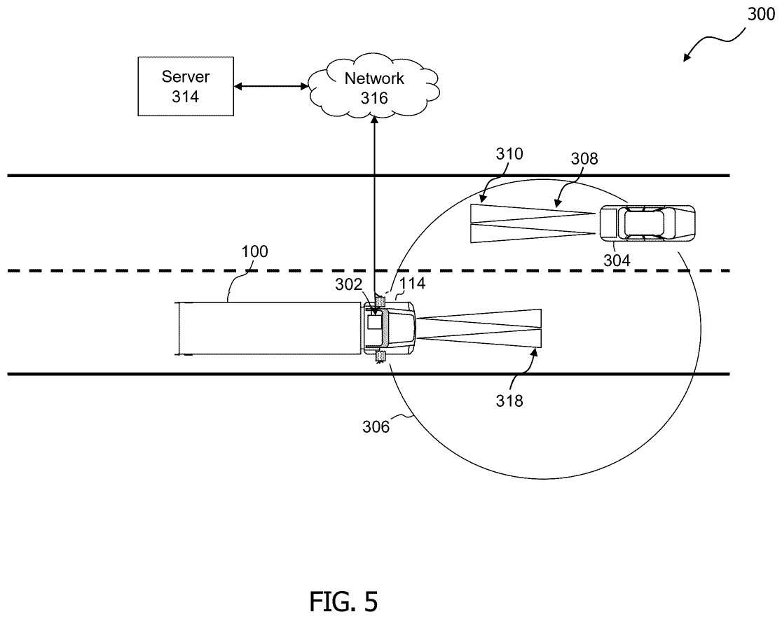

As shown in FIG. 5, the behaviors and planning module 238 may signal to the vehicle 304 using the headlights of the autonomous vehicle 100 by emitting a high beam flash 318 to signal to the vehicle 304 that the vehicle high beam status 310 of the vehicle 304 has been detected.

FIGS. 3 and 4 further illustrate the roadway environment 300 for modifying one or more actions of the autonomous vehicle 100 using the autonomy system 302. The autonomous vehicle 100 is capable of communicatively coupling to a remote server 314 via a network 316. The autonomous vehicle 100 may not necessarily connect with the network 316 or the server 314 while it is in operation (e.g., driving down the roadway). That is, the server 314 may be remote from the autonomous vehicle 100, and the autonomous vehicle 100 may deploy with all the necessary perception, localization, and vehicle control software and data necessary to complete its mission fully-autonomously or semi-autonomously.

While this disclosure refers to a truck (e.g., a tractor trailer) as the autonomous vehicle 100, it is understood that the autonomous vehicle 100 could be any type of vehicle including an automobile, a mobile industrial machine, etc. While the disclosure will discuss a self-driving or driverless autonomous system, it is understood that the autonomous system could alternatively be semi-autonomous having varying degrees of autonomy or autonomous functionality.

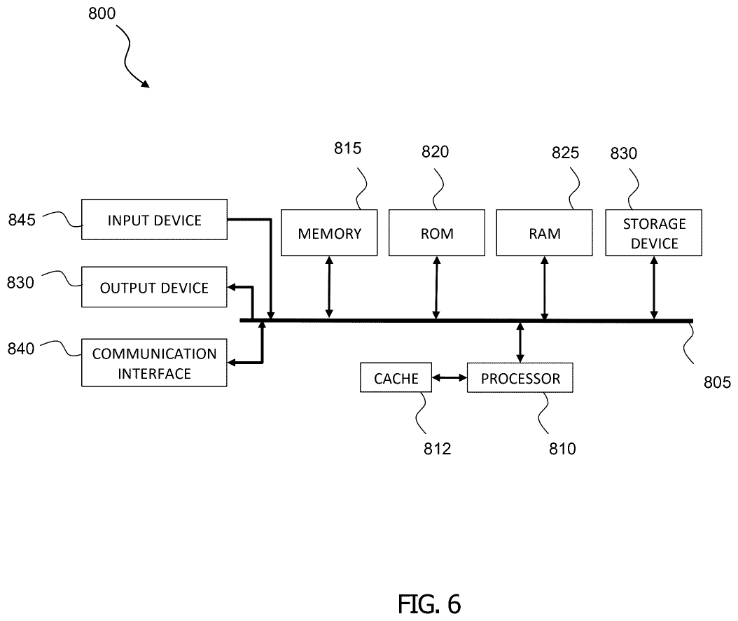

FIG. 6 illustrates an example computing system 800 that can implement various techniques, processes, functions, or methods described herein. The components of computing system 800 are shown in electrical communication with each other using a connection 805, such as a bus. The example computing system 800 includes a processing unit (CPU or processor) 810 and a computing device connection 805 that couples various computing device components, including computing device memory 815, such as a read only memory (ROM) 820 and a random access memory (RAM) 825, to processor 810.

Computing system 800 can include a cache 812 of high-speed memory connected directly with, in close proximity to, or integrated as part of processor 810. Computing system 800 can copy data from memory 815 and/or storage device 830 to cache 812 for quick access by processor 810. In this way, cache 812 can provide a performance boost that avoids processor 810 delays while waiting for data. These and other modules can control or be configured to control processor 810 to perform various actions. Other computing device memory 815 may be available for use as well. Memory 815 can include multiple different types of memory with different performance characteristics. Processor 810 can include any general purpose processor, central processing unit (CPU), or graphics processing unit (GPU) in combination with a hardware or software provision configured to control processor 810 and stored in storage device 830, as well as any special-purpose processor where software instructions are incorporated into the processor design. Processor 810 may be a self-contained system, containing multiple cores or processors, a bus, memory controller, cache, etc. A multi-core processor may be symmetric or asymmetric.

Storage device 830 is a non-volatile memory and can be one or more of a hard disk or other types of computer readable media that can store data that are accessible by a computer, such as a magnetic cassette, flash memory card, solid state memory device, digital versatile disk, cartridge, RAM 825, ROM 820, or hybrids thereof. Memory 815 or storage device 830 can include software, code, firmware, etc., for controlling processor 810. Other hardware or software modules are contemplated. Memory 815 and storage device 830 are connected to computing device connection 805. In one aspect, a hardware module that performs a particular function can include the software component stored in a computer-readable medium in connection with the necessary hardware components, such as processor 810, computing device connection 805, and so forth, to carry out the function. In the example embodiment, processor 810 may be programmed by encoding an operation or function using one or more executable instructions and providing the executable instructions in memory 815 or storage device 830.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) autonomous detection of high beam use by vehicles surrounding an autonomous vehicle; and (b) autonomous signaling by the autonomous vehicle to the vehicle with the detected high beam use.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. A system of an autonomous vehicle comprising:
one or more processors;
a plurality of sensors mounted on the autonomous vehicle and communicatively coupled to the one or more processors; and
a memory storing instructions that, when executed by the one or more processors, configure the system to:
receive, from the plurality of sensors, vehicle detection data comprising a detected vehicle;
receive, from the plurality of sensors, first sensor data, wherein the first sensor data is associated with a light amount emitted by the detected vehicle;
measure, by the plurality of sensors, a distance between the detected vehicle and the autonomous vehicle;
determine, based on the first sensor data and the measured distance between the detected vehicle and the autonomous vehicle, a vehicle high beam status of the detected vehicle, wherein the vehicle high beam status is associated with emitted high beam light by the detected vehicle;
measure, via the plurality of sensors, an ambient light;
measure, via the plurality of sensors, a light difference between the measured ambient light and the light amount emitted by the detected vehicle; and
determine, based on the light difference, the vehicle high beam status of the detected vehicle.

2. The system of claim 1, wherein the system is further configured to initiate a signal by the autonomous vehicle to the detected vehicle.

3. The system of claim 2, wherein the autonomous vehicle comprises headlights, the signal initiated by the autonomous vehicle being one or more high beam flashes of the headlights of the autonomous vehicle.

4. The system of claim 1, wherein the system is further configured to compare the first sensor data to regulatory data associated with a vehicle high beam light threshold.

5. The system of claim 1, wherein the system is further configured to input the determined vehicle high beam status into a machine learning model to categorize vehicle high beam use.

6. The system of claim 1, wherein the system is further configured to determine a presence of the detected vehicle based on the vehicle detection data.

7. The system of claim 1, wherein the plurality of sensors comprises one or more cameras, one or more of the vehicle detection data and the first sensor data being received from the one or more cameras.

8. The system of claim 1, wherein the plurality of sensors comprises one or more light detection and ranging (LiDAR) sensors, the distance between the detected vehicle and the autonomous vehicle being measured by the one or more LiDAR sensors.

9. The system of claim 1, wherein the plurality of sensors comprises one or more photodynamic sensors, one or more of the ambient light and the light difference between the measured ambient light and the light amount emitted by the detected vehicle being measured by the one or more photodynamic sensors.

10. A computer-implemented method, the method comprising:
receiving, from a plurality of sensors mounted on an autonomous vehicle, vehicle detection data comprising a detected vehicle;
receiving, from the plurality of sensors, first sensor data, wherein the first sensor data is associated with a light amount emitted by the detected vehicle;
measuring, by the plurality of sensors, a distance between the detected vehicle and the autonomous vehicle;
determining, based on the first sensor data and the measured distance between the detected vehicle and the autonomous vehicle, a vehicle high beam status of the detected vehicle, wherein the vehicle high beam status is associated with emitted high beam light by the detected vehicle;
measuring, via the plurality of sensors, an ambient light;
measuring, via the plurality of sensors, a light difference between the measured ambient light and the light amount emitted by the detected vehicle; and
determining, based on the light difference, the vehicle high beam status of the detected vehicle.

11. The computer-implemented method of claim 10, further comprising initiating a signal by the autonomous vehicle to the detected vehicle.

12. The computer-implemented method of claim 11, wherein the autonomous vehicle comprises headlights, the signal initiated by the autonomous vehicle being one or more high beam flashes of the headlights of the autonomous vehicle.

13. The computer-implemented method of claim 10, further comprising comparing the first sensor data to regulatory data associated with a vehicle high beam light threshold.

14. The computer-implemented method of claim 10, further comprising inputting the determined vehicle high beam status into a machine learning model to categorize vehicle high beam use.

15. The computer-implemented method of claim 10, further comprising determining a presence of the detected vehicle based on the vehicle detection data.

16. The computer-implemented method of claim 10, wherein the plurality of sensors comprises one or more cameras, one or more of the vehicle detection data and the first sensor data being received from the one or more cameras.

17. The computer-implemented method of claim 10, wherein the plurality of sensors comprises one or more light detection and ranging (LiDAR) sensors, the distance between the detected vehicle and the autonomous vehicle being measured by the one or more LiDAR sensors.

18. The computer-implemented method of claim 10, wherein the plurality of sensors comprises one or more photodynamic sensors, one or more of the ambient light and the light difference between the measured ambient light and the light amount emitted by the detected vehicle being measured by the one or more photodynamic sensors.

19. A non-transitory computer-readable storage medium, the non-transitory computer-readable storage medium including instructions that when executed by a computer, cause the computer to:
receive, from a plurality of sensors mounted on an autonomous vehicle, vehicle detection data comprising a detected vehicle;
receive, from the plurality of sensors, first sensor data, wherein the first sensor data is associated with a light amount emitted by the detected vehicle;
measure, by the plurality of sensors, a distance between the detected vehicle and the autonomous vehicle;
determine, based on the first sensor data and the measured distance between the detected vehicle and the autonomous vehicle, a vehicle high beam status of the detected vehicle, wherein the vehicle high beam status is associated with emitted high beam light by the detected vehicle;
measure, via the plurality of sensors, an ambient light;
measure, via the plurality of sensors, a light difference between the measured ambient light and the light amount emitted by the detected vehicle; and
determine, based on the light difference, the vehicle high beam status of the detected vehicle.

20. The non-transitory computer-readable storage medium of claim 19, wherein the plurality of sensors comprises one or more cameras, one or more light detection and ranging (LiDAR) sensors, and one or more photodynamic sensors, and wherein one or more of the vehicle detection data and the first sensor data is received from the one or more cameras, the distance between the detected vehicle and the autonomous vehicle is measured by the one or more LiDAR sensors, and one or more of the ambient light and the light difference between the measured ambient light and the light amount emitted by the detected vehicle is measured by the one or more photodynamic sensors.
